(19) United States
(12) Patent Application Publication
(10) Pub. No.: US 2016/0209624 A1
(43) Pub. Date: Jul. 21, 2016

(54) IMAGING OPTICAL SYSTEM

(71) Applicant: HOYA CORPORATION, Tokyo (JP)

(72) Inventor: Akitoshi USUI, Tokyo (JP)

(73) Assignee: HOYA CORPORATION, Tokyo (JP)

(21) Appl. No.: 14/992,259

(22) Filed: Jan. 11, 2016

(30) Foreign Application Priority Data
Jan. 16, 2015 (JP) 2015-006289

(51) Int. Cl. G02B 13/00; G02B 27/00; G02B 9/34

(52) U.S. Cl. CPC G02B 13/004; G02B 9/34; G02B 27/0025

(57) ABSTRACT

An imaging optical system includes, at the vicinity of the optical axis, a positive first lens element having an object-side convex surface, a negative second lens element having an object-side concave surface, a positive third lens element having an image-side convex surface, and a fourth lens element having an image-side concave surface. The fourth lens element is provided with aspherical surfaces on both sides such that a combined refractive power thereof has an increasingly weaker negative refractive power toward the outer periphery thereof. The following conditions (1) and (2) are satisfied:

38<νd1−νd2<80 (1),

and

−1.2<r3/f<−0.6 (2),

wherein νd1 and νd2 designate the Abbe numbers at the d-line of the first and second lens elements, respectively, r3 designates the radius of curvature of the object-side surface of the second lens element, and f designates the focal length of the imaging optical system.

### BACKGROUND OF THE INVENTION

1. Field of the Invention

The present invention relates to an imaging optical system, e.g., an imaging optical system that is installed in a mobile device (a smart phone, etc.) having a built-in camera.

2. Description of Related Art

Patent Literature Nos. 1 through 3 each disclose an imaging optical system installed in, e.g., a mobile device, having a built-in camera, configured of a positive first lens element, a negative second lens element, a positive third lens element, and a negative fourth lens element, in that order from the object side.
Patent Literature 1: Japanese Unexamined Patent Application No. 2010-60835
Patent Literature 2: Japanese Unexamined Patent Application No. 2010-49113
Patent Literature 3: Japanese Unexamined Patent Application No. 2013-148834

However, Patent Literature. Nos. 1 through 3 have the following technical problems:

In the imaging optical system of Patent Literature 1, the surface on the object side of the negative second lens element has a convex surface facing the object side at the vicinity of the optical axis, and since the negative refractive power of the negative second lens element must be borne by only the surface on the image side thereof, this is disadvantageous for correction of coma.

In the imaging optical system of Patent Literature 2, the f-number is approximately 2.8, which collects an insufficient quantity of light. Furthermore, the half angle-of-view is only less than 35 degrees; hence, miniaturization (a lower profile/slimmed-down size) and a higher optical quality cannot be both sufficiently achieved.

In the imaging optical system of Patent Literature 3, the overall length of the optical system is too long, and does not satisfy the demand for miniaturization (a lower profile/slimmed-down size).

In each imaging optical system of Patent Literature Nos. 1 through 3, correction of chromatic aberrations (axial chromatic aberration and lateral chromatic aberration) is insufficient.

### SUMMARY OF THE INVENTION

The present invention has been devised in view of the above-mentioned problems, and provides an imaging optical system having a f-number of approximately 2.4 which enables a large amount quantity of light to be collected, has a half angle-of-view of 35 degrees or more, can favorably correct coma and chromatic aberrations (axial chromatic aberration and lateral chromatic aberration), and can meet the demands for miniaturization (reduction in profile and slimming down).

According to an aspect of the present invention, an imaging optical system is provided, including a positive first lens element having a convex surface on the object side at the vicinity of the optical axis, a negative second lens element having a concave surface on the object side at the vicinity of the optical axis, a positive third lens element having a convex surface on the image side at the vicinity of the optical axis, and a negative fourth lens element having a concave surface on the image side at the vicinity of the optical axis, in that order from the object side. The negative fourth lens element is provided with an aspherical surface on the object side and on the image side thereof. The aspherical surfaces of the negative fourth lens element have profiles such that a combined refractive power thereof has an increasingly weaker negative refractive power from the optical axis toward the outer periphery thereof (away from the optical axis). The following conditions (1) and (2) are satisfied:

38<νd1−νd2<80 (1),

and

−1.2<r3/f<−0.6 (2),

wherein ν d1 designates the Abbe number with respect to the d-line of the positive first lens element, νd2 designates the Abbe number with respect to the d-line of the negative second lens element, r3 designates the radius of curvature (paraxial radius of curvature) of a surface on the object side of the negative second lens element, and f designates the entire focal length of the imaging optical system.

It is desirable for the imaging optical system to satisfy the following condition (2′) within the scope of condition (2):

−1.2<r3/f<−0.8 (2′).

It is desirable for the following condition (3) to be satisfied:

0.2≦(T12+T34)/TL<0.3 (3),

wherein T12 designates the distance along the optical axis between the surface on the image side of the positive first lens element and the surface on the object side of the negative second lens element (the air-distance between the positive first lens element and the negative second lens element), T34 designates the distance along the optical axis between the surface on the image side of the positive third lens element and the surface on the object side of the negative fourth lens element (the air-distance between the positive third lens element and the negative fourth lens element), and TL designates the distance along the optical axis between the surface on the object side of the positive first lens element and an imaging surface of the imaging optical system.

It is desirable for the following condition (4) to be satisfied:

1.55<nd1<1.70 (4),

wherein nd1 designates the refractive index at the d-line of the positive first lens element.

It is desirable for a surface on the object side of the negative fourth lens element to include an aspherical surface having a concave surface on the object side at the vicinity of the optical axis, wherein the following condition (5) is satisfied:

1.0<r7/f4<5.0 (5),

wherein r7 designates the radius of curvature (paraxial radius of curvature) of the surface on the object side of the negative fourth lens element, and f4 designates the focal length of the negative fourth lens element.

It is desirable for the imaging optical system to satisfy the following condition (5′) within the scope of condition (5):

1.0<r7/f4<4.0 (5′)

It is desirable for an air lens to be formed between (the surface on the image side of) the negative second lens element and (the surface on the object side of) the positive third lens element (the negative second lens element and the positive third lens element are not cemented to each other), and wherein the following condition (6) is satisfied:

−0.40<Pair23/P<0 (6),

wherein P designates the refractive power of the imaging optical system (inverse number of focal length), Pair23 designates the refractive power of the air lens that is formed between the negative second lens element and the positive third lens element, Pair23=(1−nd2)/r4+(nd3−1)/r5−((1−nd2)*(nd3−1))/(r4*r5)*T23, nd2 designates the refractive index at the d-line of the negative second lens element, nd3 designates the refractive index at the d-line of the positive third lens element, r4 designates the radius of curvature (paraxial radius of curvature) of a surface on the image side of the negative second lens element, r5 designates the radius of curvature (paraxial radius of curvature) of a surface on the object side of the positive third lens element, and T23 designates the distance along the optical axis between a surface on the image side of the negative second lens element and a surface on the object side of the positive third lens element (the air-distance between the negative second lens element and the positive third lens element).

It is desirable for the imaging optical system to satisfy the following condition (6′) within the scope of condition (6):

−0.40<Pair23/P<−0.01 (6′).

It is desirable for the aspherical surfaces of the negative fourth lens element to each have a profile such that a combined refractive power thereof has an increasingly weaker negative refractive power from the optical axis toward the outer periphery thereof (away from the optical axis) and changes to a positive refractive power at the outer periphery thereof.

It is desirable for a surface on the negative fourth lens element, on at least one of the object side and image side thereof, to include at least one inflection point.

In the present specification, “inflection point” refers to a point on a lens sectional profile that includes the optical axis at which a tangent line contacts the optical axis at right-angles thereto.

It is desirable for the positive first lens element to be configured of a glass molded lens element having an aspherical surface formed on each side thereof. Each of the negative second lens element, the positive third lens element and the negative fourth lens element comprises a plastic lens element, on which an aspherical surface is formed on each side thereof.

According to the present invention, an imaging optical system can be achieved that has a f-number of approximately 2.4 which enables a large amount quantity of light to be collected, has a half angle-of-view of 35 degrees or more, can favorably correct coma and chromatic aberrations (axial chromatic aberration and lateral chromatic aberration), and can meet the demands for miniaturization (reduction in profile and slimming down).

The present disclosure relates to subject matter contained in Japanese Patent Application No. 2015-006289 (filed on Jan. 16, 2015) which is expressly incorporated herein in its entirety.

### BRIEF DESCRIPTION OF THE DRAWINGS

The present invention will be discussed below in detail with reference to the accompanying drawings, in which:

FIG. 1 shows a lens arrangement of a first numerical embodiment of the imaging optical system;

FIGS. 2A, 2B, 2C and 2D show various aberrations that occurred in the lens arrangement of FIG. 1;

FIG. 3 shows a lens arrangement of a second numerical embodiment of the imaging optical system;

FIGS. 4A, 4B, 4C and 4D show various aberrations that occurred in the lens arrangement of FIG. 3;

FIG. 5 shows a lens arrangement of a third numerical embodiment of the imaging optical system;

FIGS. 6A, 6B, 6C and 6D show various aberrations that occurred in the lens arrangement of FIG. 5;

FIG. 7 shows a lens arrangement of a fourth numerical embodiment of the imaging optical system;

FIGS. 8A, 8B, 8C and 8D show various aberrations that occurred in the lens arrangement of FIG. 7;

FIG. 9 shows a lens arrangement of a fifth numerical embodiment of the imaging optical system;

FIGS. 10A, 10B, 100 and 10D show various aberrations that occurred in the lens arrangement of FIG. 9;

FIG. 11 shows a lens arrangement of a sixth numerical embodiment of the imaging optical system;

FIGS. 12A, 12B, 12C and 12D show various aberrations that occurred in the lens arrangement of FIG. 11;

FIG. 13 shows a lens arrangement of a seventh numerical embodiment of the imaging optical system;

FIGS. 14A, 14B, 14C and 14D show various aberrations that occurred in the lens arrangement of FIG. 13;

FIG. 15 shows a lens arrangement of a eighth numerical embodiment of the imaging optical system;

FIGS. 16A, 16B, 16C and 16D show various aberrations that occurred in the lens arrangement of FIG. 15;

FIG. 17 shows a lens arrangement of a ninth numerical embodiment of the imaging optical system;

FIGS. 18A, 18B, 18C and 18D show various aberrations that occurred in the lens arrangement of FIG. 17;

FIG. 19 shows a lens arrangement of a tenth numerical embodiment of the imaging optical system; and

FIGS. 20A, 20B, 20C and 20D show various aberrations that occurred in the lens arrangement of FIG. 19.

### DESCRIPTION OF THE EMBODIMENTS

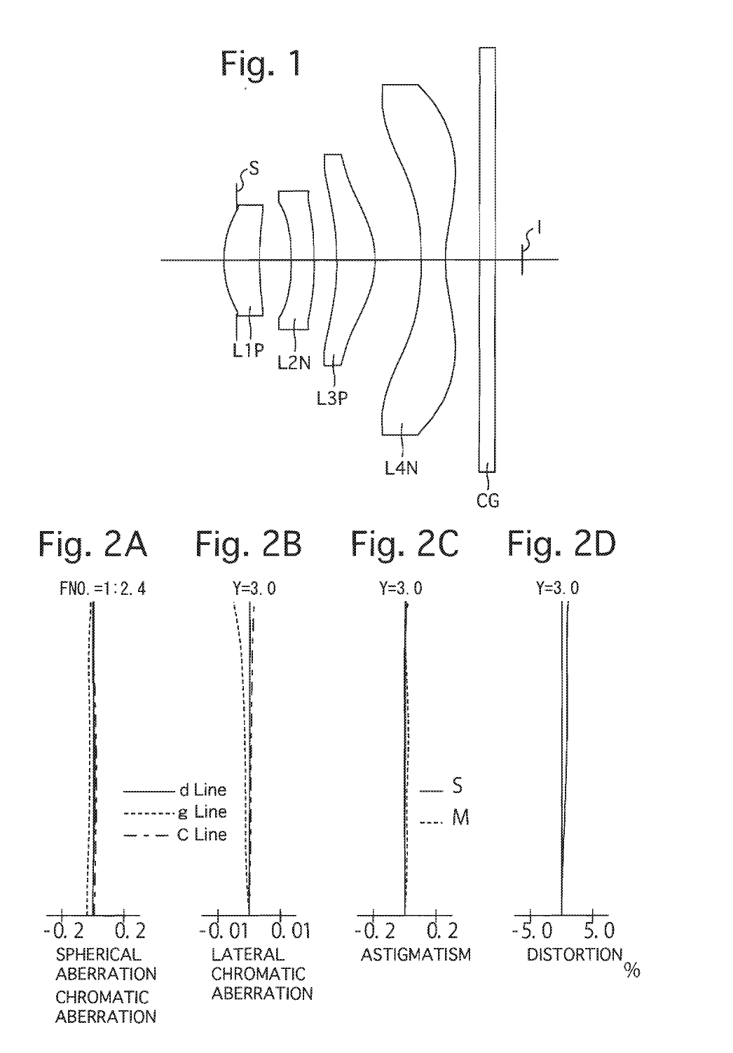

In each of first through tenth numerical embodiments, as shown in the lens arrangements of FIGS. 1, 3, 5, 7, 9, 11, 13, 15, 17 and 19, the imaging optical system of the illustrated embodiments is configured of a positive first lens element L1P, a negative second lens element L2N, a positive third lens element L3P, and a negative fourth lens element L4N, in that order from the object side (four lens elements). A cover glass CG is provided behind (on the image side of) the negative fourth lens element L4N to protect an imaging surface I of an image sensor (not shown).

In each of the first through third, and fifth through tenth numerical embodiments, the diaphragm S is provided on the periphery of the positive first lens element L1P with the position of the diaphragm S overlapping the first lens element L1P with respect to the optical axis direction. In the fourth numerical embodiment, the diaphragm S is provided between the positive first lens element L1P and the negative second lens group L2N (immediately behind the positive first lens element L1P).

The positive first lens element L1P is provided with a meniscus profile having a convex surface on the object side at the vicinity of the optical axis. By forming the first lens element L1P to have a meniscus profile having a convex surface on the object side at the vicinity of the optical axis, since the principal point of the optical system can be positioned on the object side, this is advantageous for miniaturization of the imaging optical system (a lower profile/slimmed-down size).

The negative second lens element L2N is provided with a meniscus profile having a concave surface on the object side at the vicinity of the optical axis. By forming the negative second lens element L2N to have a meniscus profile having a concave surface on the object side at the vicinity of the optical axis, the negative refractive power of the negative second lens element L2N is distributed on the object side, so that sudden divergence of light rays on the surface on the image side of the negative second lens element L2N can be prevented, and the light rays can be gently guided toward the imaging surface of the image sensor; this is advantageous for correction of coma.

The positive third lens element L3P is provided with a meniscus profile having a convex surface on the image side at the vicinity of the optical axis. By forming the positive third lens element L3P to have a meniscus profile having a convex surface on the image side at the vicinity of the optical axis, since the incident angle of the peripheral light rays can be suppressed, this is advantageous for coma correction. Furthermore, the positive third lens element L3P can be prevented from interfering with the negative fourth lens element L4N while achieving miniaturization of the imaging optical system (a lower profile/slimmed-down size).

The negative fourth lens element L4N is provided with a biconcave profile having a concave surface on the object side and on the image side at the vicinity of the optical axis. By forming the negative fourth lens element L4N to have a profile having a concave surface on the image side at the vicinity of the optical axis, since the abaxial light rays can be made incident at a high position of the fourth lens element L4N while maintaining a sufficient negative refractive power, this is advantageous for correction of coma.

The positive first lens element LIP is configured of a glass molded lens element having an aspherical surface formed on each side thereof. The negative second lens element L2N, the positive third lens element L3P and the negative fourth lens element L4N are each configured of a plastic lens element having an aspherical surface formed on each side thereof. Accordingly, by configuring the positive first lens element L1P (having a relatively strong refractive power) of a glass molded lens element having an aspherical surface on each side thereof, deterioration in optical quality that is caused by changes in temperature can be suppressed.

A negative air lens is formed between the surface on the image side of the negative second lens element L2N and the surface on the object side of the positive third lens element L3P (the negative second lens element L2N and the positive third lens element L3P are not cemented to each other).

The negative fourth lens element L4N is provided with an aspherical surface on the object side and on the image side thereof. Each aspherical surface of the negative fourth lens element L4N has a profile such that the combined refractive power thereof has an increasingly weaker negative refractive power from the optical axis toward the outer periphery (away from the optical axis), and changes to a positive refractive power at the outer periphery thereof. A surface on the negative fourth lens element L4N, on at least one of the object side and image side, has at least one inflection point. In the present specification, “inflection point” refers to a point on a lens sectional profile that includes the optical axis at which a tangent line contacts the optical axis at right-angles thereto. By forming at least one aspherical surface on the negative fourth lens element L4N in this manner, the angle of the incident light rays onto the imaging surface of the image sensor does not become too sharp, which is advantageous for maintaining telecentricity.

Furthermore, by appropriately determining the lens material of the positive first lens element L1P and the negative second lens element L2N, and the radius of curvature (paraxial radius of curvature) of the surface on the object side of the negative second lens element L2N, the imaging optical system of the illustrated embodiments can have an f-number of approximately 2.4 which enables a large amount quantity of light to be collected, a half angle-of-view of 35 degrees or more, can favorably correct coma and chromatic aberrations (axial chromatic aberration and lateral chromatic aberration), and can meet the demand for miniaturization (a lower profile/slimmed-down size). Hence, the imaging optical system of the present invention is suitable for use in, e.g., a mobile device (a smart phone, etc.) having a built-in camera, in which miniaturization (a lower profile/slimmed-down size) of the imaging optical system to the utmost limit is demanded.

Condition (1) specifies the difference in the Abbe numbers, with respect to the d-line, between the positive first lens element L1P and the negative second lens element L2P. By satisfying condition (1), chromatic aberrations (axial chromatic aberration and lateral chromatic aberration) can be favorably corrected.

If the upper limit of condition (1) is exceeded, the difference in the Abbe numbers, with respect to the d-line, between the positive first lens element L1P and the negative second lens element L2P becomes too large, so that chromatic aberrations become overcorrected.

If the lower limit of condition (1) is exceeded, the difference in the Abbe numbers, with respect to the d-line, between the positive first lens element L1P and the negative second lens element L2P becomes too small, so that correction of chromatic aberrations becomes insufficient.

Condition (2) and condition (2′) normalize the radius of curvature (paraxial radius of curvature) of the surface on the object side of the negative second lens element L2N with respect to the focal length of the entire imaging optical system. By satisfying condition (2), coma can be favorably amended, and miniaturization (a lower profile/slimmed-down size) of the imaging optical system can be achieved while reliably preventing interference between the positive first lens element L1P and the negative second lens element L2N. This advantageous effect can be made even more prominent by satisfying condition (2′).

If the upper limit of condition (2) is exceeded, the curvature of the surface on the object side of the negative second lens element L2N becomes too sharp (the radius of curvature becomes too small), so that coma becomes overcorrected. Furthermore, (with upper limit of condition (2) exceeded) since there is a risk of the surface on the object side of the negative second lens element L2N interfering with the surface on the image side of the positive first lens element L1P, in order to prevent such interference from occurring, it becomes essential to arrange the positive first lens element L1P and the negative second lens element L2N to have an extra amount of space (distance in the optical axis direction) therebetween, thereby hindering miniaturization of the imaging optical system.

If the lower limit of condition (2) and (2′) is exceeded, the curvature of the surface on the object side of the negative second lens element L2N becomes too gentle, so that the negative refractive power of the negative second lens element L2N becomes insufficient, thereby being disadvantageous for correction of coma.

Condition (3) specifies the relationship between three parameters: the distance along the optical axis between the surface on the image side of the positive first lens element L1P and the surface on the object side of the negative second lens element L2N, the distance along the optical axis between the surface on the image side of the positive third lens element L3P and the surface on the object side of the negative fourth lens element L4N, and the distance along the optical axis between the surface on the object side of the positive first lens element L1P and the imaging surface of the image sensor. By satisfying condition (3), since an appropriate air distance (distance between the lens elements) can be ensured and the light rays can be made incident on the negative lens elements (the negative second lens element L2N and the negative fourth lens element L4N) at a high position (from the optical axis), coma can be favorably corrected. Furthermore, by satisfying condition (3), the demands for miniaturization (a lower profile/slimmed-down size) can be met for the imaging optical system while maintaining telecentricity.

If the upper limit of condition (3) is exceeded, either one or both of the air distance between the positive first lens element L1P and the negative second lens element L2N, and the air distance between the positive third lens element L3P and the negative fourth lens element L4N become (s) too large, thereby not being able to meet the demands for miniaturization. Furthermore, the distance between the negative fourth lens element L4N and the imaging surface I decreases, so that it becomes difficult to attain telecentricity.

If the lower limit of condition (3) is exceeded, either one or both of the air distance between the positive first lens element L1P and the negative second lens element L2N, and the air distance between the positive third lens element L3P and the negative fourth lens element L4N become (s) too small, and it becomes difficult for the light rays to be made incident on the negative lens elements (the negative second lens element L2N and the negative fourth lens element L4N) at a high position (from the optical axis), which is disadvantageous with regard to correction of coma.

Condition (4) specifies the refractive index at the d-line of the positive first lens element L1P. By satisfying condition (4), spherical aberration can be favorably corrected, and miniaturization (a lower profile/slimmed-down size) of the imaging optical system can be achieved.

If the upper limit of condition (4) is exceeded, the profile of the positive first lens element L1P cannot be appropriately determined, so that it becomes difficult to correct spherical aberration.

If the lower limit of condition (4) is exceeded, the radius of curvature of each surface of the positive first lens element L1P would need to be set to a small radius in order to maintain the refractive power required for the positive first lens element L1P, thereby causing difficulties in achieving miniaturization of the positive first lens element L1P, in turn, the entire imaging optical system.

Condition (5) and condition (5′) normalize the radius of curvature (paraxial radius of curvature) of the surface on the object side of the negative fourth lens element L4N with respect to the focal length of the negative fourth lens element L4N. By satisfying condition (5), the radius of curvature of each surface of the negative fourth lens element L4N can be appropriately determined while maintaining a negative refractive power required for the negative fourth lens element L4N, so that a sufficient distance can be ensured between the surface on the image side of the negative fourth lens element L4N to the imaging surface. Furthermore, by satisfying condition (5), excessive divergence of light rays at the surface on the object side of the negative fourth lens element L4N can be suppressed, so that miniaturization (a lower profile/slimmed-down size) of the imaging optical system can be achieved. This advantageous effect can be made even more prominent by satisfying condition (5′).

If the upper limit of condition (5) is exceeded, since the negative refractive power of the surface on the object side of the negative fourth lens element L4N becomes insufficient, in order to maintain a negative refractive power required for the negative fourth lens element L4N, the curvature of the surface on the image side of the negative fourth lens element L4N would need to be set to a sharp curvature, resulting in difficulties in ensuring a sufficient distance from the surface on the image side of the negative fourth lens element L4N and the imaging surface I.

If the lower limit of condition (5) and (5′) is exceeded, the negative refractive power of the surface on the object side of the negative fourth lens element L4N becomes too strong, so that the light rays excessively diverge, thereby causing difficulties in miniaturization of the imaging optical system.

Conditions (6) and (6′) relate to the refractive power of the air lens formed between the negative second lens element L2N and the positive third lens element L3P, and specify an extremely small negative refractive power for this air lens. By satisfying condition (6), coma can be favorably corrected, and interference between the negative second lens element L2N and the positive third lens element L3P can be reliably prevented while achieving miniaturization (a lower profile/slimmed-down size) of the imaging optical system. This advantageous effect can be made even more prominent by satisfying condition (6′).

If the upper limit of condition (6) is exceeded, since a negative refractive power cannot be provided for the air lens that is formed between the negative second lens element L2N and the positive third lens element L3P, correction of coma becomes insufficient.

If the lower limit of condition (6) and condition (6′) is exceeded, the difference between the radius of curvature of the surface on the image side of the negative second lens element L2N and the surface on the object side of the positive third lens element L3P becomes too large, so that since it becomes essential to arrange the negative second lens element L2N and the positive third lens element L3P to have an extra amount of space (distance in the optical axis direction) therebetween so as not to interfere with each other, miniaturization of the imaging optical system becomes difficult.

Specific first through tenth numerical embodiments will be herein discussed. In the aberration diagrams and the tables, the d-line, g-line and C-line show aberrations at their respective wave-lengths; S designates the sagittal image, M designates the meridional image, R designates the radius of curvature, D designates the lens thickness or distance between lenses, Nd designates the refractive index at the d-line, and vd designates the Abbe number with respect to the d-line. The unit used for the various lengths is defined in millimeters (mm).

An aspherical surface which is rotationally symmetrical about the optical axis is defined as:

x=cy²/(1+[1−{1+K}c²y²]^{1/2})+A4y⁴+A6y⁶+A8y⁸+A10y¹⁰+A12y¹² . . .

wherein ‘c’ designates the curvature (1/r) of the aspherical vertex, ‘y’ designates the distance from the optical axis, ‘K’ designates the conic coefficient, A4 designates a fourth-order aspherical coefficient, A6 designates a sixth-order aspherical coefficient, A8 designates an eighth-order aspherical coefficient, A10 designates a tenth-order aspherical coefficient, A12 designates a twelfth-order aspherical coefficient, and ‘x’ designates the amount of sag.

### Numerical Embodiment 1

FIGS. 1 through 2D and Tables 1 through 3 show a first numerical embodiment of the imaging optical system. FIG. 1 shows a lens arrangement of the first numerical embodiment of the imaging optical system. FIGS. 2A, 2B, 2C and 2D show various aberrations that occurred in the lens arrangement shown in FIG. 1. Table 1 shows the lens surface data, Table 2 shows various data of the imaging optical system, and Table 3 shows aspherical surface data.

The imaging optical system of the first numerical embodiment is configured of a positive first lens element L1P, a negative second lens element L2N, a positive third lens element L3P, and a negative fourth lens element L4N, in that order from the object side.

The positive first lens element L1P has a meniscus profile having a convex surface on the object side, at the vicinity of the optical axis.

The negative second lens element L2N has a meniscus profile having a concave surface on the object side, at the vicinity of the optical axis.

The positive third lens element L3P has a meniscus profile having a convex surface on the image side, at the vicinity of the optical axis.

The negative fourth lens element L4N has a concave surface both on the object side and on the image side, at the vicinity of the optical axis.

The positive first lens element L1P is configured of a glass molded lens element having an aspherical surface on each side thereof. Each of the negative second lens element L2N, the positive third lens element L3P and the negative fourth lens element L4N is configured of a plastic lens element having an aspherical surface on each side thereof.

A cover glass CG for protecting the imaging surface I of the image sensor (not shown) is provided behind the negative fourth lens element L4N.

A diaphragm S is provided on the periphery of the positive first lens element L1P with the position of the diaphragm S overlapping that of the first lens element L1P with respect to the optical axis direction.

A “negative” air lens is formed between the surface on the image side of the negative second lens element L2N and the surface on the object side of the positive third lens element L3P (the negative second lens element L2N and the positive third lens element L3P are not cemented to each other).

The negative fourth lens element L4N is provided with an aspherical surface on both the object side and the image side thereof.

The combined refractive power of the aspherical surfaces of the negative fourth lens element L4N has an increasingly weaker negative refractive power from the optical axis toward the outer periphery (away from the optical axis), and changes to a positive refractive power at the outer periphery thereof.

The image-side surface of the negative fourth lens element L4N has at least one inflection point.

TABLE 1
LENS SURFACE DATA

| Surf. No. | R | D | Nd | νd |
|---|---|---|---|---|
| (Diaphragm) | ∞ | −0.191 | | |
| 1 | 1.363 | 0.480 | 1.55332 | 71.7 |
| 2 | 3.987 | 0.430 | | |
| 3 | −3.661 | 0.310 | 1.64220 | 22.4 |
| 4 | −6.479 | 0.310 | | |
| 5 | −3.272 | 0.520 | 1.54358 | 55.7 |
| 6 | −1.109 | 0.620 | | |
| 7 | −5.230 | 0.320 | 1.53484 | 55.7 |
| 8 | 1.730 | 0.459 | | |
| 9 | ∞ | 0.210 | 1.51680 | 64.2 |
| 10 | ∞ | 0.341 | | |

TABLE 2
IMAGING OPTICAL SYSTEM DATA

| | |
|---|---|
| Focal length of imaging optical system [mm]: | 3.39 |
| f-number | 2.4 |
| Angle of view [deg.]: | 41.2 |
| Maximum image height [mm]: | 3.00 |

TABLE 3
ASPHERICAL SURFACE DATA

| Surf. No. | K | A4 | A6 | A8 | A10 | A12 |
|---|---|---|---|---|---|---|
| 1 | 0.074 | 4.14290E−03 | 2.34950E−03 | −4.95370E−02 | 1.00030E−01 | −1.52440E−01 |
| 2 | −12.000 | −8.72340E−04 | −8.40060E−03 | −3.03260E−01 | 6.59390E−01 | −7.45950E−01 |
| 3 | 17.947 | −2.24770E−01 | 2.89490E−01 | −7.19640E−01 | 6.68430E−01 | 9.73090E−01 |
| 4 | 20.057 | −1.28790E−01 | 1.09210E−01 | −1.33160E−01 | 1.54760E−01 | 3.80870E−02 |
| 5 | 1.124 | 3.99150E−02 | −2.58580E−02 | 5.87660E−02 | −1.07020E−01 | 8.73010E−02 |
| 6 | −4.016 | −1.21520E−01 | 1.53810E−01 | −7.29940E−02 | 3.21050E−02 | −1.19970E−02 |
| 7 | −0.363 | −7.75730E−02 | 2.16230E−02 | 5.90890E−04 | −1.42760E−04 | −1.59750E−04 |
| 8 | −10.252 | −8.29500E−02 | 3.16850E−02 | −1.05080E−02 | 2.22300E−03 | −2.71790E−04 |

| Surf. No. | A14 | A16 | A18 | A20 |
|---|---|---|---|---|
| 1 | | | | |
| 2 | | | | |
| 3 | −1.15100E+00 | | | |
| 4 | 1.22320E−02 | 6.67620E−02 | 8.06520E−02 | −1.50000E−01 |
| 5 | −2.36180E−02 | | | |
| 6 | 1.73830E−03 | | | |
| 7 | 2.29830E−05 | | | |
| 8 | 1.45000E−05 | | | |

### Numerical Embodiment 2

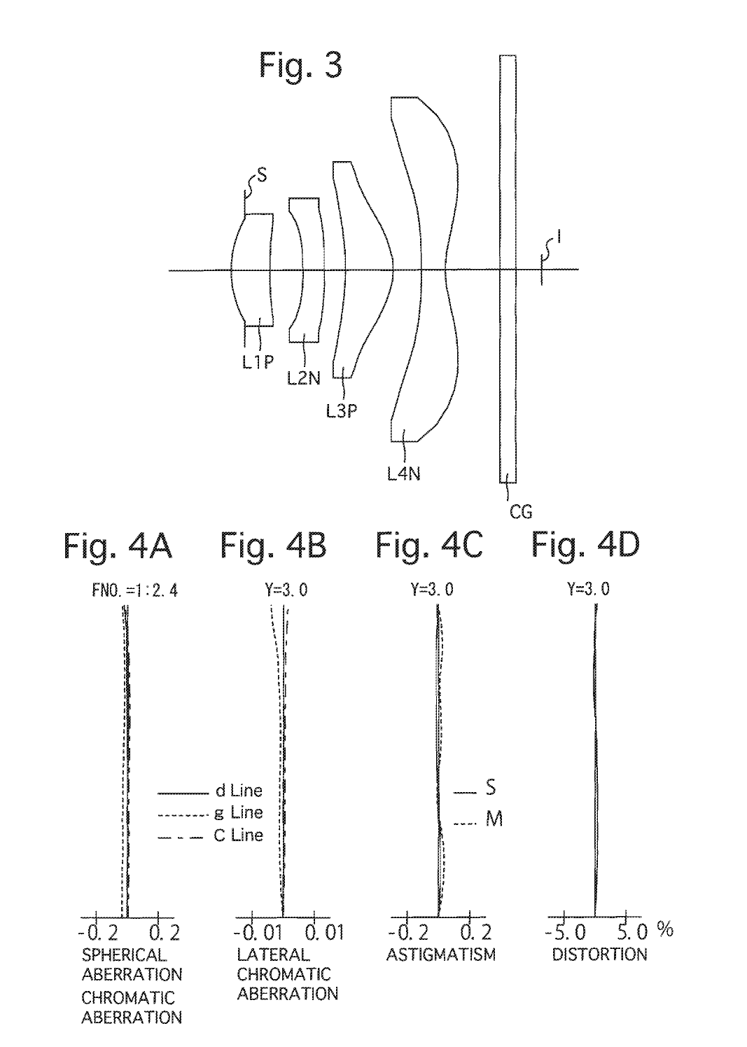

FIGS. 3 through 4D and Tables 4 through 6 show a second numerical embodiment of the imaging optical system. FIG. 3 shows a lens arrangement of the second numerical embodiment of the imaging optical system. FIGS. 4A, 4B, 4C and 4D show various aberrations that occurred in the lens arrangement shown in FIG. 3. Table 4 shows the lens surface data, Table 5 shows various data of the imaging optical system, and Table 6 shows aspherical surface data.

The fundamental lens arrangement of the second numerical embodiment is the same as that of the first numerical embodiment.

TABLE 4
LENS SURFACE DATA

| Surf. No. | R | D | N d | ν d |
|---|---|---|---|---|
| (Diaphragm) | ∞ | −0.187 | | |
| 1 | 1.407 | 0.518 | 1.55332 | 71.7 |
| 2 | 4.082 | 0.450 | | |
| 3 | −3.688 | 0.290 | 1.64250 | 22.5 |
| 4 | −9.911 | 0.287 | | |
| 5 | −3.444 | 0.647 | 1.54358 | 55.7 |
| 6 | −0.881 | 0.384 | | |
| 7 | −7.767 | 0.320 | 1.54358 | 55.7 |
| 8 | 1.284 | 0.734 | | |
| 9 | ∞ | 0.210 | 1.51680 | 64.2 |
| 10 | ∞ | 0.330 | | |

TABLE 5
IMAGING OPTICAL SYSTEM DATA

| | |
|---|---|
| Focal length of imaging optical system [mm]: | 3.40 |
| f-number | 2.4 |
| Angle of view [deg.]: | 41.3 |
| Maximum image height [mm]: | 3.00 |

TABLE 6
ASPHERICAL SURFACE DATA

| Surf. No. | K | A4 | A6 | A8 | A10 | A12 |
|---|---|---|---|---|---|---|
| 1 | −0.009 | 1.36233E−02 | −2.57084E−03 | −6.06883E−02 | 1.70909E−01 | −1.81403E−01 |
| 2 | −15.074 | 5.76901E−03 | 1.94531E−02 | −3.48882E−01 | 5.82119E−01 | −5.46783E−01 |
| 3 | 15.000 | −2.09767E−01 | 7.19996E−02 | −3.75244E−01 | 6.39587E−01 | 5.95203E−02 |
| 4 | 22.510 | −1.38745E−01 | 9.46344E−02 | −1.52527E−01 | 1.63223E−01 | 4.74957E−02 |
| 5 | 1.822 | 2.43349E−02 | 1.00227E−03 | 6.24238E−02 | −1.12636E−01 | 8.31045E−02 |
| 6 | −3.840 | −1.81672E−01 | 1.89573E−01 | −7.17843E−02 | 3.04727E−02 | −1.29800E−02 |
| 7 | 0.340 | −5.51227E−02 | 1.50546E−02 | 4.35024E−04 | −7.70776E−05 | −1.36378E−04 |
| 8 | −9.571 | −8.43989E−02 | 3.26246E−02 | −1.12357E−02 | 2.36044E−03 | −2.60979E−04 |

| Surf. No. | A14 | A16 | A18 | A20 |
|---|---|---|---|---|
| 1 | | | | |
| 2 | | | | |
| 3 | −5.54858E−01 | | | |
| 4 | −2.57881E−02 | 6.54625E−04 | 3.99270E−05 | −5.02194E−03 |
| 5 | −2.29626E−02 | | | |
| 6 | 1.83451E−03 | | | |
| 7 | 1.85827E−05 | | | |
| 8 | 1.06977E−05 | | | |

### Numerical Embodiment 3

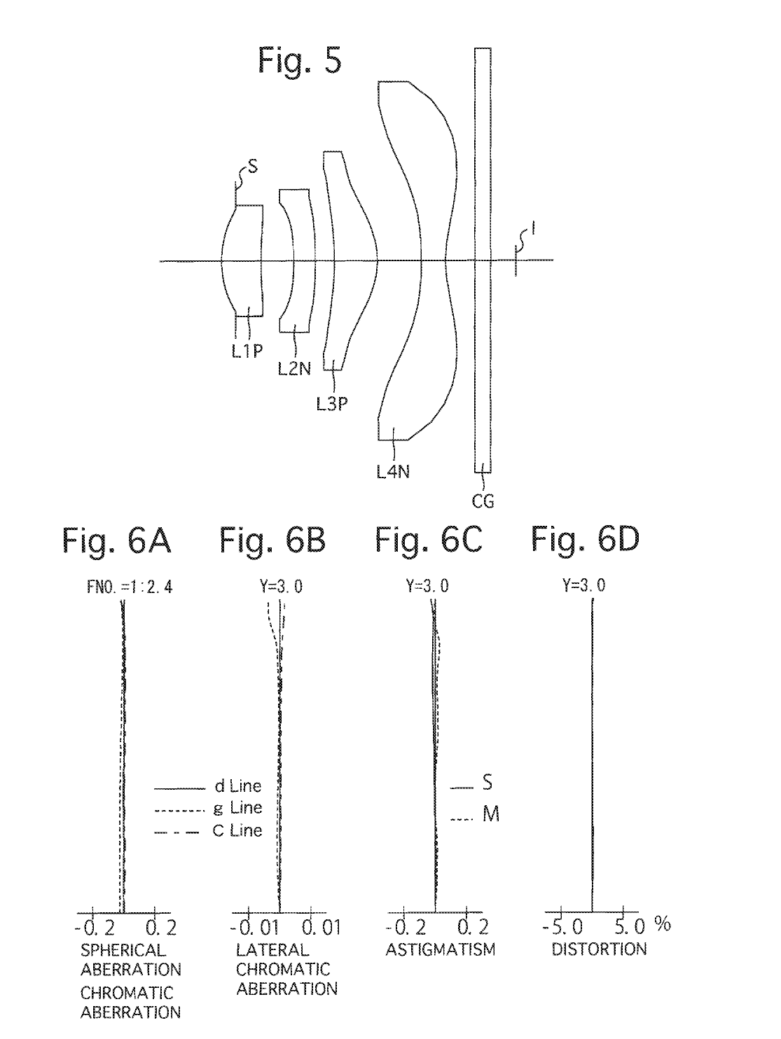

FIGS. 5 through 6D and Tables 7 through 9 show a third numerical embodiment of the imaging optical system. FIG. 5 shows a lens arrangement of the third numerical embodiment of the imaging optical system. FIGS. 6A, 6B, 6C and 6D show various aberrations that occurred in the lens arrangement shown in FIG. 5. Table 7 shows the lens surface data, Table 8 shows various data of the imaging optical system, and Table 9 shows aspherical surface data.

The fundamental lens arrangement of the third numerical embodiment is the same as those of the first and second numerical embodiments.

TABLE 7
LENS SURFACE DATA

| Surf. No. | R | D | N d | ν d |
|---|---|---|---|---|
| (Diaphragm) | ∞ | −0.187 | | |
| 1 | 1.328 | 0.529 | 1.49710 | 81.6 |
| 2 | 5.382 | 0.444 | | |
| 3 | −3.661 | 0.290 | 1.64250 | 22.5 |
| 4 | −9.198 | 0.261 | | |
| 5 | −3.644 | 0.584 | 1.54358 | 55.7 |
| 6 | −1.020 | 0.596 | | |
| 7 | −3.956 | 0.320 | 1.54358 | 55.7 |
| 8 | 1.549 | 0.397 | | |
| 9 | ∞ | 0.210 | 1.51680 | 64.2 |
| 10 | ∞ | 0.342 | | |

TABLE 8
IMAGING OPTICAL SYSTEM DATA

| | |
|---|---|
| Focal length of imaging optical system [mm]: | 3.33 |
| f-number | 2.4 |
| Angle of view [deg.]: | 42.0 |
| Maximum image height [mm]: | 3.00 |

TABLE 9
ASPHERICAL SURFACE DATA

| Surf. No. | K | A4 | A6 | A8 | A10 | A12 |
|---|---|---|---|---|---|---|
| 1 | 0.016 | 5.77139E−03 | −2.39430E−02 | −3.06608E−02 | 1.48624E−01 | −2.49154E−01 |
| 2 | −12.724 | −2.88636E−02 | 8.49726E−03 | −3.27613E−01 | 5.79636E−01 | −7.50623E−01 |
| 3 | 17.947 | −2.32256E−01 | 1.09524E−01 | −3.90709E−01 | 6.43698E−01 | 1.46244E−01 |
| 4 | 23.111 | −1.47948E−01 | 9.92394E−02 | −1.46256E−01 | 1.64000E−01 | 4.49217E−02 |
| 5 | 1.203 | 3.98532E−02 | −7.82843E−03 | 6.21354E−02 | −1.12399E−01 | 8.35119E−02 |
| 6 | −3.983 | −1.60269E−01 | 1.89144E−01 | −7.33864E−02 | 2.98005E−02 | −1.30227E−02 |
| 7 | −0.380 | −6.31182E−02 | 1.93930E−02 | 4.25115E−04 | −9.01621E−05 | −1.45836E−04 |
| 8 | −9.606 | −8.47205E−02 | 3.41944E−02 | −1.14776E−02 | 2.31615E−03 | −2.55047E−04 |

| Surf. No. | A14 | A16 | A18 | A20 |
|---|---|---|---|---|
| 1 | | | | |
| 2 | | | | |
| 3 | −6.16207E−01 | | | |
| 4 | −1.25207E−02 | −8.96695E−04 | −2.69467E−03 | −6.06462E−03 |
| 5 | −2.31585E−02 | | | |
| 6 | 2.00437E−03 | | | |
| 7 | 1.92800E−05 | | | |
| 8 | 1.12202E−05 | | | |

### Numerical Embodiment 4

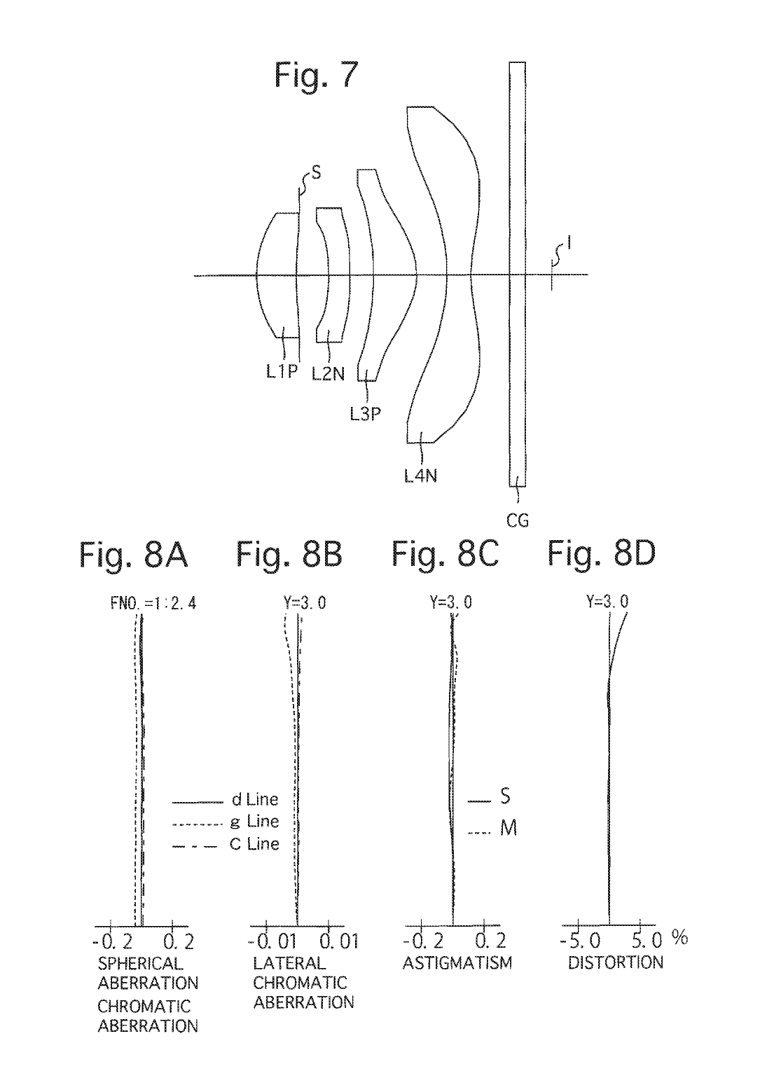

FIGS. 7 through 8D and Tables 10 through 12 show a fourth numerical embodiment of the imaging optical system. FIG. 7 shows a lens arrangement of the fourth numerical embodiment of the imaging optical system. FIGS. 8A, 8B, 8C and 8D show various aberrations that occurred in the lens arrangement shown in FIG. 7. Table 10 shows the lens surface data, Table 11 shows various data of the imaging optical system, and Table 12 shows aspherical surface data.

The fundamental lens arrangement of the fourth numerical embodiment is the same as those of the first through third numerical embodiment except for the diaphragm S being provided between the positive first lens element L1P and the negative second lens element L2N (immediately behind the positive first lens element L1P).

TABLE 10
LENS SURFACE DATA

| Surf. No. | R | D | N d | ν d |
|---|---|---|---|---|
| 1 | 1.381 | 0.535 | 1.55332 | 71.7 |
| 2 | 4.428 | 0.032 | | |
| (Diaphragm) | ∞ | 0.407 | | |
| 3 | −3.111 | 0.290 | 1.60641 | 27.2 |
| 4 | −6.061 | 0.320 | | |
| 5 | −3.522 | 0.585 | 1.54358 | 55.7 |
| 6 | −0.865 | 0.411 | | |
| 7 | −2.303 | 0.320 | 1.54358 | 55.7 |
| 8 | 1.673 | 0.519 | | |
| 9 | ∞ | 0.210 | 1.51680 | 64.2 |
| 10 | ∞ | 0.343 | | |

TABLE 11
IMAGING OPTICAL SYSTEM DATA

| | |
|---|---|
| Focal length of imaging optical system [mm]: | 3.30 |
| f-number | 2.4 |
| Angle of view [deg.]: | 41.5 |
| Maximum image height [mm]: | 3.00 |

TABLE 12
ASPHERICAL SURFACE DATA

| Surf. No. | K | A4 | A6 | A8 | A10 | A12 | A14 |
|---|---|---|---|---|---|---|---|
| 1 | −0.111 | 8.02537E−03 | 9.53604E−03 | −5.21495E−02 | 9.17864E−02 | −1.56922E−01 | |
| 2 | −14.922 | −1.71309E−02 | 2.16151E−02 | −4.44056E−01 | 5.30406E−01 | −2.97537E−01 | |
| 3 | 9.752 | −2.49858E−01 | 3.16583E−03 | −2.75770E−01 | 6.37195E−01 | −1.02051E+00 | 1.24768E+00 |
| 4 | −3.474 | −1.67994E−01 | 7.87460E−02 | −2.07911E−01 | 1.82864E−01 | 2.09956E−01 | −7.24328E−02 |
| 5 | 5.348 | 2.00645E−02 | −1.59803E−02 | 6.38258E−02 | −1.13129E−01 | 8.97107E−02 | −2.39945E−02 |
| 6 | −3.524 | −1.70973E−01 | 1.81594E−01 | −6.54930E−02 | 2.95696E−02 | −1.39965E−02 | 2.20503E−03 |
| 7 | −14.466 | −6.22083E−02 | 1.67963E−02 | 2.64288E−04 | 1.75437E−06 | −1.36932E−04 | 1.64218E−05 |
| 8 | −16.357 | −7.01197E−02 | 2.66562E−02 | −1.05151E−02 | 2.34094E−03 | −2.82644E−04 | 1.43834E−05 |

### Numerical Embodiment 5

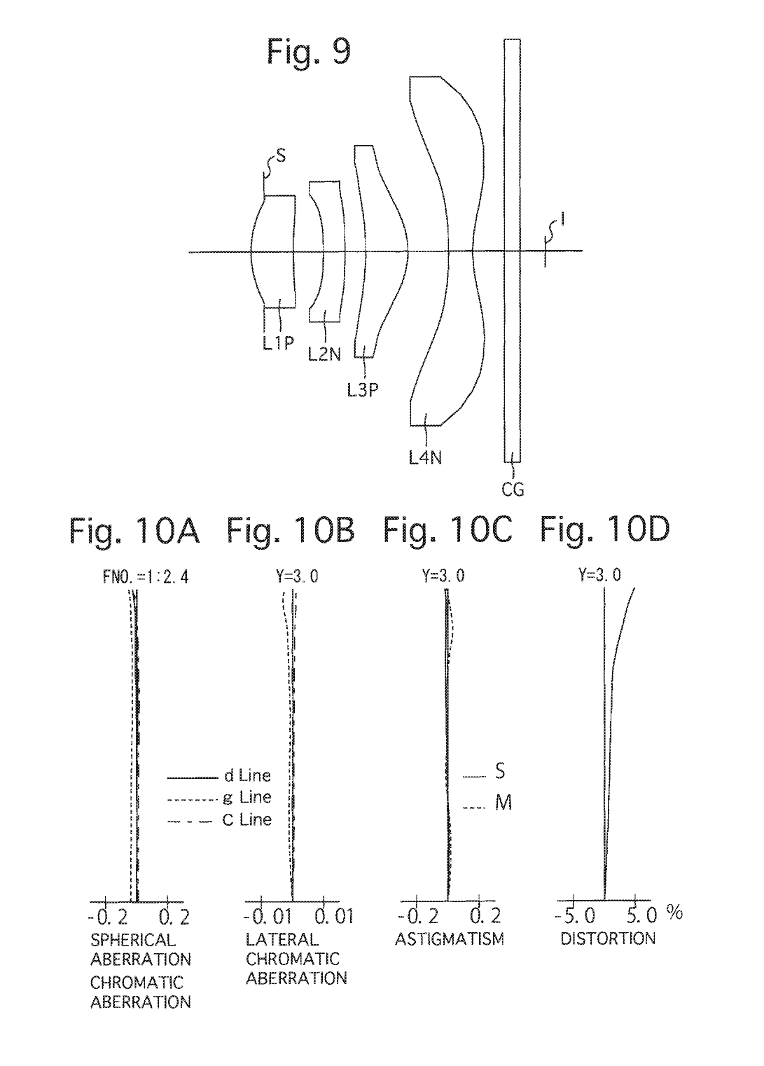

FIGS. 9 through 10D and Tables 13 through 15 show a fifth numerical embodiment of the imaging optical system. FIG. 9 shows a lens arrangement of the fifth numerical embodiment of the imaging optical system. FIGS. 10A, 10B, 100 and 10D show various aberrations that occurred in the lens arrangement shown in FIG. 9. Table 13 shows the lens surface data, Table 14 shows various data of the imaging optical system, and Table 15 shows aspherical surface data.

The fundamental lens arrangement of the fifth numerical embodiment is the same as those of the first through third numerical embodiments.

TABLE 13
LENS SURFACE DATA

| Surf. No. | R | D | N d | ν d |
|---|---|---|---|---|
| (Diaphragm) | ∞ | −0.182 | | |
| 1 | 1.386 | 0.567 | 1.55332 | 71.7 |
| 2 | 4.627 | 0.413 | | |
| 3 | −3.722 | 0.290 | 1.60641 | 27.2 |
| 4 | −11.245 | 0.283 | | |
| 5 | −3.249 | 0.575 | 1.54358 | 55.7 |
| 6 | −0.980 | 0.548 | | |
| 7 | −4.663 | 0.320 | 1.54358 | 55.7 |
| 8 | 1.545 | 0.424 | | |
| 9 | ∞ | 0.210 | 1.51680 | 64.2 |
| 10 | ∞ | 0.342 | | |

TABLE 14
IMAGING OPTICAL SYSTEM DATA

| | |
|---|---|
| Focal length of imaging optical system [mm]: | 3.31 |
| f-number | 2.4 |
| Angle of view [deg.]: | 40.9 |
| Maximum image height [mm]: | 3.00 |

TABLE 15
ASPHERICAL SURFACE DATA

| Surf. No. | K | A4 | A6 | A8 | A10 | A12 | A14 |
|---|---|---|---|---|---|---|---|
| 1 | −0.009 | 3.92316E−03 | 2.16069E−04 | −5.86863E−02 | 1.51032E−01 | −2.12013E−01 | |
| 2 | −15.074 | −1.98428E−02 | 4.20978E−03 | −3.65323E−01 | 5.67117E−01 | −6.81595E−01 | |
| 3 | 17.924 | −2.39077E−01 | 7.27904E−02 | −3.70924E−01 | 5.99751E−01 | 1.48398E−02 | −5.96015E−01 |
| 4 | 22.510 | −1.46381E−01 | 9.31503E−02 | −1.42049E−01 | 1.77488E−01 | 5.00781E−02 | −2.89029E−02 |
| 5 | 1.822 | 4.55919E−02 | −5.70498E−03 | 6.19801E−02 | −1.10936E−01 | 8.36165E−02 | −2.37254E−02 |
| 6 | −3.840 | −1.62192E−01 | 1.91633E−01 | −7.17730E−02 | 2.91771E−02 | −1.32435E−02 | 2.01474E−03 |
| 7 | 0.340 | −4.84667E−02 | 1.24563E−02 | 7.52092E−04 | 3.68861E−05 | −1.34853E−04 | 1.49387E−05 |
| 8 | −9.571 | −8.01108E−02 | 3.15027E−02 | −1.12199E−02 | 2.35956E−03 | −2.62267E−04 | 1.14178E−05 |

### Numerical Embodiment 6

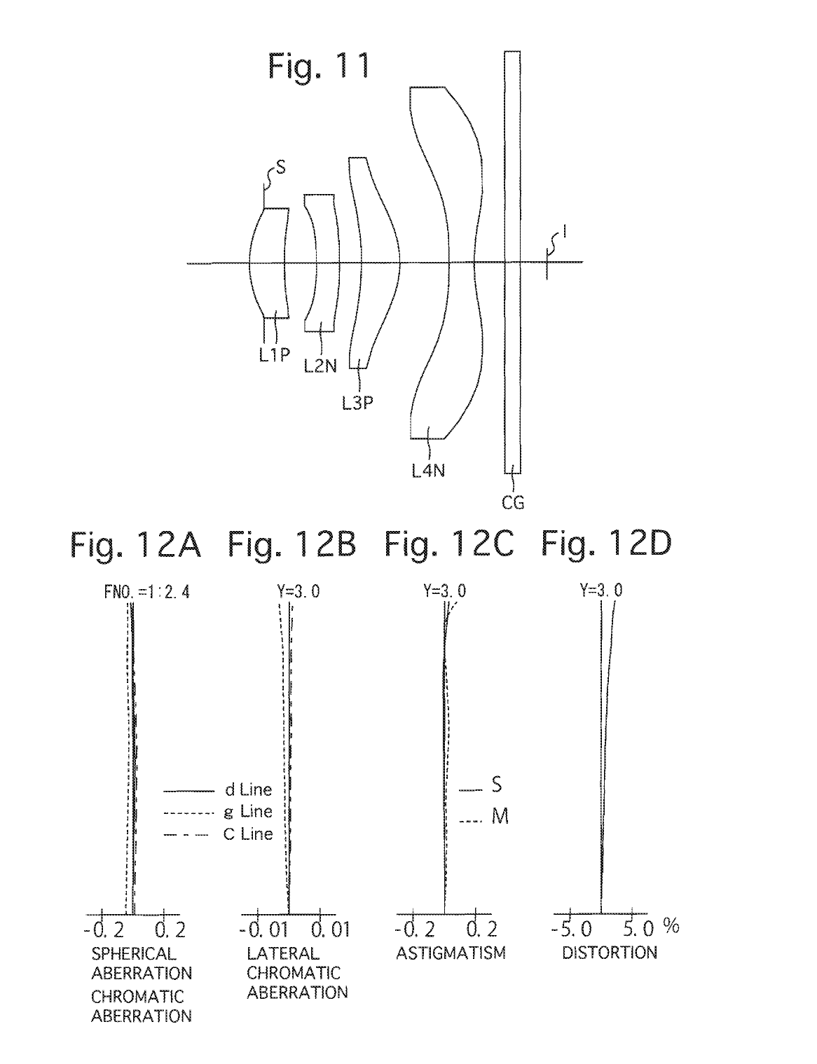

FIGS. 11 through 12D and Tables 16 through 18 show a sixth numerical embodiment of the imaging optical system. FIG. 11 shows a lens arrangement of the sixth numerical embodiment of the imaging optical system. FIGS. 12A, 12B, 12C and 12D show various aberrations that occurred in the lens arrangement shown in FIG. 11. Table 16 shows the lens surface data, Table 17 shows various data of the imaging optical system, and Table 18 shows aspherical surface data.

The fundamental lens arrangement of the sixth numerical embodiment is the same as those of the first through third numerical embodiments and the fifth numerical embodiment.

TABLE 16
LENS SURFACE DATA

| Surf. No. | R | D | N d | ν d |
|---|---|---|---|---|
| (Diaphragm) | ∞ | −0.187 | | |
| 1 | 1.396 | 0.466 | 1.61881 | 63.9 |
| 2 | 3.446 | 0.438 | | |
| 3 | −3.661 | 0.309 | 1.64220 | 22.4 |
| 4 | −6.303 | 0.300 | | |
| 5 | −3.150 | 0.521 | 1.54358 | 55.7 |
| 6 | −1.167 | 0.668 | | |
| 7 | −5.550 | 0.330 | 1.53484 | 55.7 |
| 8 | 1.927 | 0.411 | | |
| 9 | ∞ | 0.210 | 1.51680 | 64.2 |
| 10 | ∞ | 0.341 | | |

TABLE 17
IMAGING OPTICAL SYSTEM DATA

| | |
|---|---|
| Focal length of imaging optical system [mm]: | 3.39 |
| f-number | 2.4 |
| Angle of view [deg.]: | 40.9 |
| Maximum image height [mm]: | 3.00 |

TABLE 18
ASPHERICAL SURFACE DATA

| | | | | | |
|---|---|---|---|---|---|
| Surf. No. | K | A4 | A6 | A8 | A10 |
| 1 | 0.102 | 4.95297E−03 | 4.17295E−03 | −4.87850E−02 | 9.59558E−02 |
| | A12 | | | | |
| | −1.44128E−01 | | | | |
| Surf. No. | K | A4 | A6 | A8 | A10 |
| 2 | −9.869 | 9.30895E−03 | −5.31510E−03 | −3.14491E−01 | 6.39821E−01 |
| | A12 | | | | |
| | −7.33092E−01 | | | | |
| Surf. No. | K | A4 | A6 | A8 | A10 |
| 3 | 17.950 | −2.24682E−01 | 2.84995E−01 | −7.19601E−01 | 6.64551E−01 |
| | A12 | A14 | | | |
| | 9.44819E−01 | −1.25085E+00 | | | |
| Surf. No. | K | A4 | A6 | A8 | A10 |
| 4 | 17.081 | −1.22115E−01 | 1.13798E−01 | −1.32244E−01 | 1.54013E−01 |
| | A12 | A14 | A16 | A18 | A20 |
| | 3.72235E−02 | 1.19061E−02 | 6.69746E−02 | 8.09126E−02 | −1.50693E−01 |
| Surf. No. | K | A4 | A6 | A8 | A10 |
| 5 | 0.793 | 4.37669E−02 | −2.48487E−02 | 5.92008E−02 | −1.06894E−01 |
| | A12 | A14 | | | |
| | 8.72739E−02 | −2.36894E−02 | | | |
| Surf. No. | K | A4 | A6 | A8 | A10 |
| 6 | −4.273 | −1.24479E−01 | 1.53315E−01 | −7.32305E−02 | 3.20241E−02 |
| | A12 | A14 | | | |
| | −1.18869E−02 | 1.74570E−03 | | | |
| Surf. No. | K | A4 | A6 | A8 | A10 |
| 7 | 0.539 | −7.87320E−02 | 2.17282E−02 | 6.16964E−04 | −1.39981E−04 |
| | A12 | A14 | | | |
| | −1.59964E−04 | 2.27249E−05 | | | |
| Surf. No. | K | A4 | A6 | A8 | A10 |
| 8 | −10.698 | −8.56746E−02 | 3.19005E−02 | −1.04283E−02 | 2.22882E−03 |
| | A12 | A14 | | | |
| | −2.72372E−04 | 1.43000E−05 | | | |

### Numerical Embodiment 7

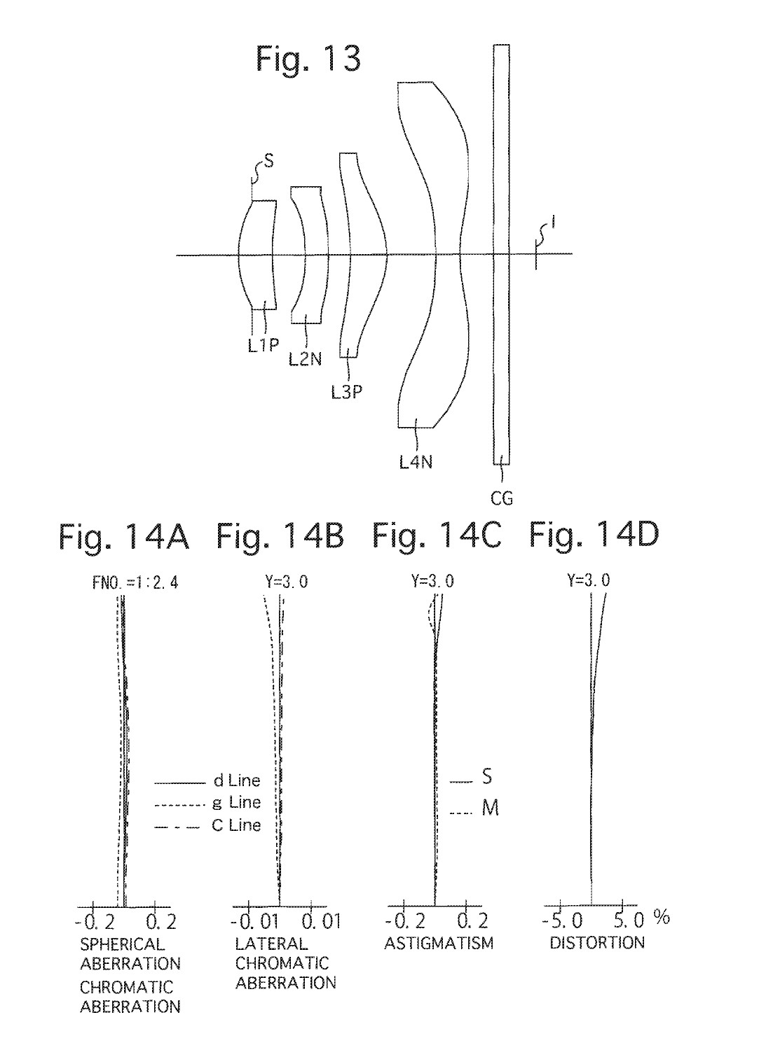

FIGS. 13 through 14D and Tables 19 through 21 show a seventh numerical embodiment of the imaging optical system. FIG. 13 shows a lens arrangement of the seventh numerical embodiment of the imaging optical system. FIGS. 14A, 14B, 14C and 14D show various aberrations that occurred in the lens arrangement shown in FIG. 13. Table 19 shows the lens surface data, Table 20 shows various data of the imaging optical system, and Table 21 shows aspherical surface data.

The fundamental lens arrangement of the seventh numerical embodiment is the same as those of the first through third numerical embodiments and the fifth and sixth numerical embodiments.

TABLE 19
LENS SURFACE DATA

| Surf. No. | R | D | N d | ν d |
|---|---|---|---|---|
| (Diaphragm) | ∞ | −0.184 | | |
| 1 | 1.419 | 0.457 | 1.61881 | 63.9 |
| 2 | 3.746 | 0.448 | | |
| 3 | −2.544 | 0.312 | 1.63548 | 23.9 |
| 4 | −4.331 | 0.300 | | |
| 5 | −3.465 | 0.496 | 1.54358 | 55.7 |
| 6 | −1.114 | 0.662 | | |
| 7 | −5.401 | 0.320 | 1.53484 | 55.7 |
| 8 | 1.750 | 0.455 | | |
| 9 | ∞ | 0.210 | 1.51680 | 64.2 |
| 10 | ∞ | 0.341 | | |

TABLE 20
IMAGING OPTICAL SYSTEM DATA

| | |
|---|---|
| Focal length of imaging optical system [mm]: | 3.39 |
| f-number | 2.4 |
| Angle of view [deg.]: | 40.8 |
| Maximum image height [mm] : | 3.00 |

TABLE 21
ASPHERICAL SURFACE DATA

| | | | | | |
|---|---|---|---|---|---|
| Surf. No. | K | A4 | A6 | A8 | A10 |
| 1 | 0.110 | 3.41065E−03 | 1.02725E−02 | −4.32503E−02 | 9.64408E−02 |
| | A12 | | | | |
| | −1.66182E−01 | | | | |
| Surf. No. | K | A4 | A6 | A8 | A10 |
| 2 | −10.717 | 7.38397E−03 | −8.34878E−03 | −3.14123E−01 | 6.48599E−01 |
| | A12 | | | | |
| | −7.03145E−01 | | | | |
| Surf. No. | K | A4 | A6 | A8 | A10 |
| 3 | 8.023 | −2.16041E−01 | 2.98971E−01 | −6.85109E−01 | 7.15321E−01 |
| | A12 | A14 | | | |
| | 1.00784E+00 | −1.17711E+00 | | | |
| Surf. No. | K | A4 | A6 | A8 | A10 |
| 4 | 16.849 | −1.14262E−01 | 1.23185E−01 | −1.23949E−01 | 1.62962E−01 |
| | A12 | A14 | A16 | A18 | A20 |
| | 4.68072E−02 | 2.08966E−02 | 7.25557E−02 | 8.26506E−02 | −1.55040E−01 |
| Surf. No. | K | A4 | A6 | A8 | A10 |
| 5 | −0.136 | 4.25245E−02 | −2.53650E−02 | 5.78048E−02 | −1.07762E−01 |
| | A12 | A14 | | | |
| | 8.70939E−02 | −2.34556E−02 | | | |
| Surf. No. | K | A4 | A6 | A8 | A10 |
| 6 | −4.126 | −1.20931E−01 | 1.56980E−01 | −7.20655E−02 | 3.23122E−02 |
| | A12 | A14 | | | |
| | −1.19151E−02 | 1.64345E−03 | | | |
| Surf. No. | K | A4 | A6 | A8 | A10 |
| 7 | 1.137 | −7.74870E−02 | 2.18431E−02 | 6.37024E−04 | −1.38794E−04 |
| | A12 | A14 | | | |
| | −1.59948E−04 | 2.25061E−05 | | | |
| Surf. No. | K | A4 | A6 | A8 | A10 |
| 8 | −11.607 | −8.26864E−02 | 3.12905E−02 | −1.04029E−02 | 2.23395E−03 |
| | A12 | A14 | | | |
| | −2.72338E−04 | 1.41453E−05 | | | |

### Numerical Embodiment 8

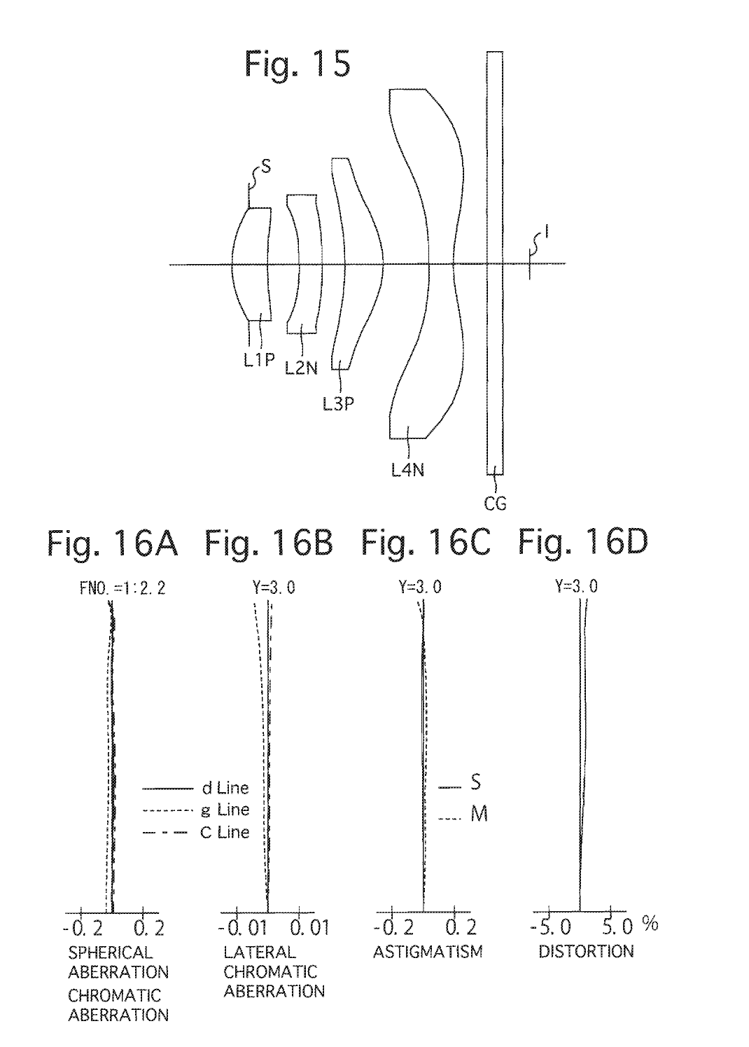

FIGS. 15 through 16D and Tables 22 through 24 show an eighth numerical embodiment of the imaging optical system. FIG. 15 shows a lens arrangement of the eighth numerical embodiment of the imaging optical system. FIGS. 16A, 16B, 16C and 16D show various aberrations that occurred in the lens arrangement shown in FIG. 15. Table 22 shows the lens surface data, Table 23 shows various data of the imaging optical system, and Table 24 shows aspherical surface data.

The fundamental lens arrangement of the eighth numerical embodiment is the same as those of the first through third numerical embodiments and the fifth through seventh numerical embodiments.

TABLE 22
LENS SURFACE DATA

| Surf. No. | R | D | N d | ν d |
|---|---|---|---|---|
| (Diaphragm) | ∞ | −0.227 | | |
| 1 | 1.366 | 0.480 | 1.55332 | 71.7 |
| 2 | 3.978 | 0.430 | | |
| 3 | −3.685 | 0.310 | 1.64220 | 22.4 |
| 4 | −6.445 | 0.310 | | |
| 5 | −3.292 | 0.520 | 1.54358 | 55.7 |
| 6 | −1.109 | 0.620 | | |
| 7 | −5.358 | 0.320 | 1.53484 | 55.7 |
| 8 | 1.721 | 0.454 | | |
| 9 | ∞ | 0.210 | 1.51680 | 64.2 |
| 10 | ∞ | 0.341 | | |

TABLE 23
IMAGING OPTICAL SYSTEM DATA

| | |
|---|---|
| Focal length of imaging optical system [mm]: | 3.37 |
| f-number | 2.2 |
| Angle of view [deg]: | 41.3 |
| Maximum image height [mm]: | 3.00 |

TABLE 24
ASPHERICAL SURFACE DATA

| | | | | | |
|---|---|---|---|---|---|
| Surf. No. | K | A4 | A6 | A8 | A10 |
| 1 | 0.071 | 5.05386E−03 | 3.33887E−03 | −4.87344E−02 | 1.01470E−01 |
| | A12 | | | | |
| | −1.45287E−01 | | | | |
| Surf. No. | K | A4 | A6 | A8 | A10 |
| 2 | −11.256 | −6.30573E−05 | −6.47644E−03 | −2.97526E−01 | 6.72280E−01 |
| | A12 | | | | |
| | −7.28945E−01 | | | | |
| Surf. No. | K | A4 | A6 | A8 | A10 |
| 3 | 17.695 | −2.24925E−01 | 2.87351E−01 | −7.17181E−01 | 6.74003E−01 |
| | A12 | A14 | | | |
| | 9.74560E−01 | −1.16662E+00 | | | |
| Surf. No. | K | A4 | A6 | A8 | A10 |
| 4 | 20.596 | −1.28194E−01 | 1.09141E−01 | −1.33785E−01 | 1.53574E−01 |
| | A12 | A14 | A16 | A18 | A20 |
| | 3.75697E−02 | 1.31207E−02 | 6.70184E−02 | 8.10699E−02 | −1.50000E−01 |
| Surf. No. | K | A4 | A6 | A8 | A10 |
| 5 | 1.118 | 4.02649E−02 | −2.63164E−02 | 5.87475E−02 | −1.06905E−01 |
| | A12 | A14 | | | |
| | 8.72225E−02 | −2.38771E−02 | | | |
| Surf. No. | K | A4 | A6 | A8 | A10 |
| 6 | −4.037 | −1.22674E−01 | 1.54028E−01 | −7.28085E−02 | 3.21219E−02 |
| | A12 | A14 | | | |
| | −1.20465E−02 | 1.66839E−03 | | | |
| Surf. No. | K | A4 | A6 | A8 | A10 |
| 7 | 0.134 | −7.81062E−02 | 2.15897E−02 | 5.85082E−04 | −1.43189E−04 |
| | A12 | A14 | | | |
| | −1.59546E−04 | 2.30989E−05 | | | |
| Surf. No. | K | A4 | A6 | A8 | A10 |
| 8 | −10.187 | −8.19092E−02 | 3.14244E−02 | −1.05158E−02 | 2.22416E−03 |
| | A12 | A14 | | | |
| | −2.71622E−04 | 1.45147E−05 | | | |

### Numerical Embodiment 9

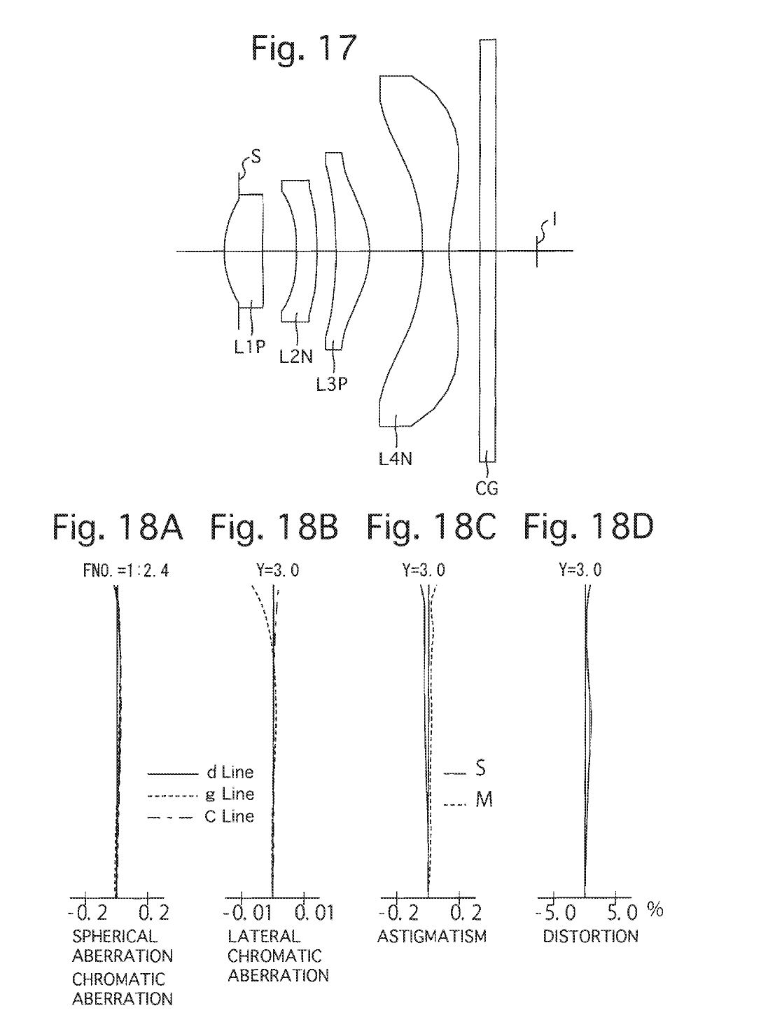

FIGS. 17 through 18D and Tables 25 through 27 show a ninth numerical embodiment of the imaging optical system. FIG. 17 shows a lens arrangement of the ninth numerical embodiment of the imaging optical system. FIGS. 18A, 18B, 18C and 18D show various aberrations that occurred in the lens arrangement shown in FIG. 17. Table 25 shows the lens surface data, Table 26 shows various data of the imaging optical system, and Table 27 shows aspherical surface data.

The fundamental lens arrangement of the ninth numerical embodiment is the same as those of the first through third numerical embodiments and the fifth through eighth numerical embodiments.

TABLE 25
LENS SURFACE DATA

| Surf. No. | R | D | N d | ν d |
|---|---|---|---|---|
| (Diaphragm) | ∞ | −0.197 | | |
| 1 | 1.309 | 0.515 | 1.43700 | 95.1 |
| 2 | 9.325 | 0.463 | | |
| 3 | −2.768 | 0.274 | 1.64220 | 22.4 |
| 4 | −6.403 | 0.261 | | |
| 5 | −4.692 | 0.455 | 1.54358 | 55.7 |
| 6 | −1.177 | 0.718 | | |
| 7 | −4.181 | 0.351 | 1.53484 | 55.7 |
| 8 | 1.977 | 0.413 | | |
| 9 | ∞ | 0.210 | 1.51680 | 64.2 |
| 10 | ∞ | 0.341 | | |

TABLE 26
IMAGING OPTICAL SYSTEM DATA

| | |
|---|---|
| Focal length of imaging optical system [mm]: | 3.39 |
| f-number | 2.4 |
| Angle of view [deg]: | 41.3 |
| Maximum image height [mm]: | 3.00 |

TABLE 27
ASPHERICAL SURFACE DATA

| Surf. No. | K | A4 | A6 | A8 | A10 | A12 |
|---|---|---|---|---|---|---|
| 1 | 0.016 | −1.74450E−03 | −8.66538E−03 | −3.77746E−02 | 1.08598E−01 | −2.18400E−01 |
| 2 | −14.031 | −2.47252E−02 | 8.12526E−03 | −3.14399E−01 | 6.08381E−01 | −6.94921E−01 |
| 3 | 8.000 | −2.01441E−01 | 1.78044E−01 | −3.72193E−01 | 6.11782E−01 | 1.44770E−01 |
| 4 | 22.760 | −1.38738E−01 | 1.01783E−01 | −1.50952E−01 | 1.59588E−01 | 4.91484E−02 |
| 5 | 4.108 | 2.24353E−02 | −2.05465E−02 | 6.05143E−02 | −1.12103E−01 | 8.27929E−02 |
| 6 | −4.648 | −1.52233E−01 | 1.87103E−01 | −7.45793E−02 | 2.96480E−02 | −1.28220E−02 |
| 7 | −1.056 | −6.87264E−02 | 1.93826E−02 | 4.06677E−04 | −7.74721E−05 | −1.44909E−04 |
| 8 | −10.719 | −7.72012E−02 | 3.25746E−02 | −1.14281E−02 | 2.31001E−03 | −2.56373E−04 |

| Surf. No. | A14 | A16 | A18 | A20 |
|---|---|---|---|---|
| 1 | | | | |
| 2 | | | | |
| 3 | −5.24622E−01 | | | |
| 4 | −8.77167E−03 | 5.82377E−04 | −2.72586E−03 | −4.10774E−03 |
| 5 | −2.17740E−02 | | | |
| 6 | 2.07233E−03 | | | |
| 7 | 1.97901E−05 | | | |
| 8 | 1.15722E−05 | | | |

### Numerical Embodiment 10

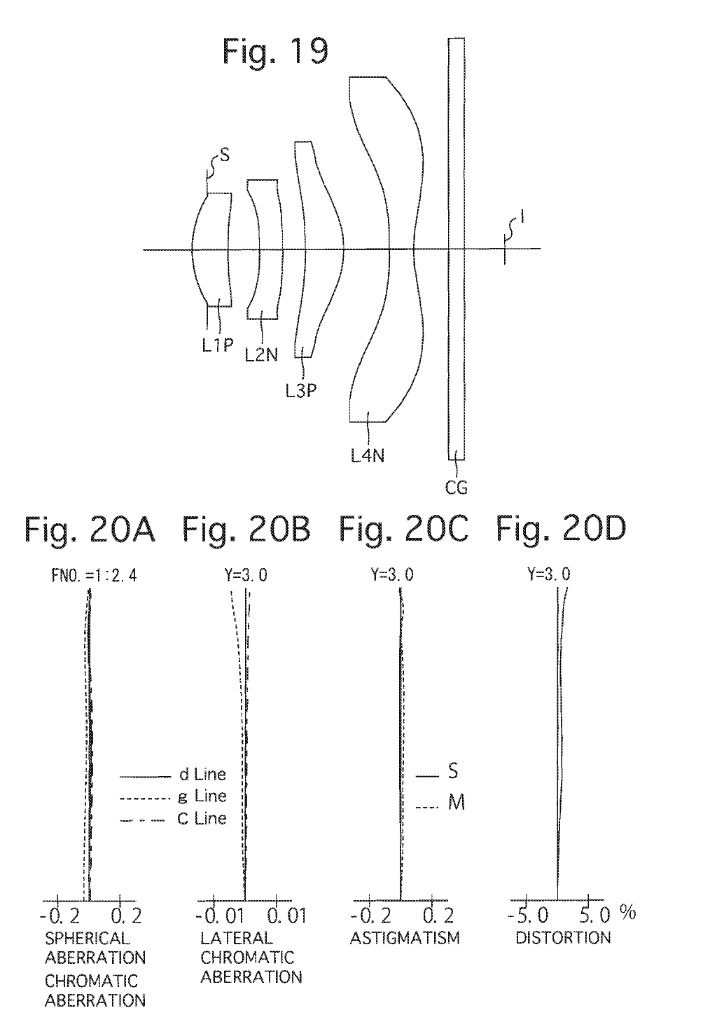

FIGS. 19 through 20D and Tables 28 through 30 show a tenth numerical embodiment of the imaging optical system. FIG. 19 shows a lens arrangement of the tenth numerical embodiment of the imaging optical system. FIGS. 20A, 20B, 20C and 20D show various aberrations that occurred in the lens arrangement shown in FIG. 19. Table 28 shows the lens surface data, Table 29 shows various data of the imaging optical system, and Table 30 shows aspherical surface data.

The fundamental lens arrangement of the tenth numerical embodiment is the same as those of the first through third numerical embodiments and the fifth through ninth numerical embodiments.

TABLE 28
LENS SURFACE DATA

| Surf. No. | R | D | Nd | νd |
|---|---|---|---|---|
| (Diaphragm) | ∞ | −0.180 | | |
| 1 | 1.374 | 0.480 | 1.55332 | 71.7 |
| 2 | 3.960 | 0.430 | | |
| 3 | −4.059 | 0.310 | 1.64220 | 22.4 |
| 4 | −9.212 | 0.310 | | |
| 5 | −4.118 | 0.520 | 1.54358 | 55.7 |
| 6 | −1.149 | 0.620 | | |
| 7 | −5.370 | 0.320 | 1.53484 | 55.7 |
| 8 | 1.735 | 0.471 | | |
| 9 | ∞ | 0.210 | 1.51680 | 64.2 |
| 10 | ∞ | 0.341 | | |

TABLE 29
IMAGING OPTICAL SYSTEM DATA

| | |
|---|---|
| Focal length of imaging optical system [mm]: | 3.40 |
| f-number | 2.4 |
| Angle of view [deg]: | 41.0 |
| Maximum image height [mm]: | 3.00 |

TABLE 30
ASPHERICAL SURFACE DATA

| Surf. No. | K | A4 | A6 | A8 | A10 | A12 |
|---|---|---|---|---|---|---|
| 1 | −0.344 | 2.47352E−02 | 5.36876E−03 | 5.13825E−03 | 1.04844E−03 | −6.07541E−02 |
| 2 | −24.859 | 2.24481E−02 | 3.47837E−02 | −5.71378E−01 | 1.20055E+00 | −1.03626E+00 |
| 3 | 21.806 | −2.33868E−01 | 2.89333E−01 | −7.66577E−01 | 6.50303E−01 | 1.20877E+00 |
| 4 | −2.232 | −1.50163E−01 | 1.00441E−01 | −1.39714E−01 | 1.52168E−01 | 3.67003E−02 |
| 5 | −1.100 | 2.28446E−02 | −2.02950E−02 | 4.78847E−02 | −9.88543E−02 | 9.10778E−02 |
| 6 | −4.231 | −1.24236E−01 | 1.54157E−01 | −7.10648E−02 | 3.40225E−02 | −1.17593E−02 |
| 7 | 0.624 | −9.80575E−02 | 2.97660E−02 | 7.04005E−04 | −3.99644E−04 | −1.86812E−04 |
| 8 | −10.167 | −8.90516E−02 | 3.34576E−02 | −1.09435E−02 | 2.31791E−03 | −2.81814E−04 |

| Surf. No. | A14 | A16 | A18 | A20 |
|---|---|---|---|---|
| 1 | | | | |
| 2 | | | | |
| 3 | −1.31237E+00 | | | |
| 4 | 1.58336E−02 | 6.66050E−02 | 8.41832E−02 | −1.50000E−01 |
| 5 | −2.72433E−02 | | | |
| 6 | 1.11137E−03 | | | |
| 7 | 3.13029E−05 | | | |
| 8 | 1.48393E−05 | | | |

The numerical values of each condition for each of the first through tenth numerical embodiments are shown in Table 31.

TABLE 31

| | Embod. 1 | Embod. 2 | Embod. 3 | Embod. 4 |
|---|---|---|---|---|
| Cond. (1) | 49.27 | 49.20 | 59.09 | 44.47 |
| Cond. (2) | −1.08 | −1.08 | −1.10 | −0.94 |
| Cond. (3) | 0.26 | 0.20 | 0.26 | 0.21 |
| Cond. (4) | 1.553 | 1.553 | 1.50 | 1.553 |
| Cond. (5) | 2.19 | 3.88 | 1.97 | 1.33 |
| Cond. (6) | −0.21 | −0.31 | −0.25 | −0.16 |
| | Embod. 5 | Embod. 6 | Embod. 7 | Embod. 8 |
| Cond. (1) | 44.47 | 41.44 | 39.95 | 49.27 |
| Cond. (2) | −1.13 | −1.08 | −0.75 | −1.09 |
| Cond. (3) | 0.24 | 0.28 | 0.28 | 0.26 |
| Cond. (4) | 1.553 | 1.62 | 1.62 | 1.553 |
| Cond. (5) | 2.22 | 2.11 | 2.22 | 2.23 |
| Cond. (6) | −0.37 | −0.22 | −0.011 | −0.20 |
| | Embod. 9 | Embod. 10 | | |
| Cond. (1) | 72.69 | 49.27 | | |
| Cond. (2) | −0.82 | −1.20 | | |
| Cond. (3) | 0.295 | 0.26 | | |
| Cond. (4) | 1.44 | 1.553 | | |
| Cond. (5) | 1.70 | 2.22 | | |
| Cond. (6) | −0.04 | −0.20 | | |

As can be understood from Table 31, the first through tenth embodiments satisfy conditions (1) and (2). Furthermore, as can be understood from the aberration diagrams, the various aberrations are suitably corrected.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An imaging optical system comprising a positive first lens element having a convex surface on the object side at the vicinity of the optical axis, a negative second lens element having a concave surface on the object side at the vicinity of the optical axis, a positive third lens element having a convex surface on the image side at the vicinity of the optical axis, and a negative fourth lens element having a concave surface on the image side at the vicinity of the optical axis, in that order from the object side,
wherein said negative fourth lens element is provided with an aspherical surface on the object side and on the image side thereof,
wherein the aspherical surfaces of said negative fourth lens element have profiles such that a combined refractive power thereof has an increasingly weaker negative refractive power from the optical axis toward the outer periphery thereof, and
wherein the following conditions (1) and (2) are satisfied:
38<νd1−νd2<80 (1), and
−1.2<r3/f<−0.6 (2), wherein
νd1 designates the Abbe number with respect to the d-line of said positive first lens element,
νd2 designates the Abbe number with respect to the d-line of said negative second lens element,
r3 designates the radius of curvature of a surface on the object side of said negative second lens element, and
f designates the entire focal length of said imaging optical system.

2. The imaging optical system according to claim 1, wherein the following condition (3) is satisfied:
0.2≦(T12+T34)/TL<0.3 (3), wherein
T12 designates the distance along the optical axis between the surface on the image side of said positive first lens element and the surface on the object side of said negative second lens element,
T34 designates the distance along the optical axis between the surface on the image side of said positive third lens element and the surface on the object side of said negative fourth lens element, and
TL designates the distance along the optical axis between the surface on the object side of said positive first lens element and an imaging surface of said imaging optical system.

3. The imaging optical system according to claim 1, wherein the following condition (4) is satisfied:
1.55<nd1<1.70 (4), wherein
nd1 designates the refractive index at the d-line of said positive first lens element.

4. The imaging optical system according to claim 1, wherein a surface on the object side of said negative fourth lens element comprises an aspherical surface having a concave surface on the object side at the vicinity of the optical axis, wherein the following condition (5) is satisfied:
1.0<r7/f4<5.0 (5), wherein
r7 designates the radius of curvature of the surface on the object side of said negative fourth lens element, and
f4 designates the focal length of said negative fourth lens element.

5. The imaging optical system according to claim 1, wherein an air lens is formed between said negative second lens element and said positive third lens element, and wherein the following condition (6) is satisfied:
−0.40<Pair23/P<0 (6), wherein
P designates the refractive power of said imaging optical system,
Pair23 designates the refractive power of said air lens that is formed between said negative second lens element and said positive third lens element,
Pair23=(1−nd2)/r4+(nd3−1)/r5−((1−nd2)*(nd3−1))/(r4*r5)*T23,
nd2 designates the refractive index at the d-line of said negative second lens element,
nd3 designates the refractive index at the d-line of said positive third lens element,
r4 designates the radius of curvature of a surface on the image side of said negative second lens element,
r5 designates the radius of curvature of a surface on the object side of said positive third lens element, and
T23 designates the distance along the optical axis between a surface on the image side of said negative second lens element and a surface on the object side of said positive third lens element.

6. The imaging optical system according to claim 1, wherein the aspherical surfaces of said negative fourth lens element each has a profile such that a combined refractive power thereof has an increasingly weaker negative refractive power from the optical axis toward the outer periphery thereof and changes to a positive refractive power at the outer periphery thereof.

7. The imaging optical system according to claim 1, wherein a surface on said negative fourth lens element, on at least one of the object side and image side thereof, includes at least one inflection point.

8. The imaging optical system according to claim 1, wherein said positive first lens element comprises a glass molded lens element having an aspherical surface formed on each side thereof, and
wherein each of said negative second lens element, said positive third lens element and said negative fourth lens element comprises a plastic lens element, on which an aspherical surface is formed on each side thereof.
